(19) United States
(12) Patent Application Publication
(10) Pub. No.: US 2015/0077853 A1
(43) Pub. Date: Mar. 19, 2015

(54) Single-Longitudinal Mode Laser with High Resolution Filter

(71) Applicant: Chaozhi Wan, Arcadia, CA (US)

(72) Inventor: Chaozhi Wan, Arcadia, CA (US)

(21) Appl. No.: 14/028,538

(22) Filed: Sep. 17, 2013

(51) Int. Cl. H01S 3/00

(52) U.S. Cl. CPC H01S 3/0078
USPC 359/566

(57) ABSTRACT

A single longitudinal mode laser in the present invention is described with an external high resolution filter to select a single longitudinal mode as the laser output from a multiple longitudinal mode microchip laser. The high resolution filter comprises at least one grating and a plurality of optical components to disperse the multiple longitudinal modes of the microchip laser and select a single longitudinal mode. The high resolution filter may have a single, double, triple, or quadruple-pass structure, which causes the laser beam to be diffracted by the grating once, twice, three, or four times, respectively, for increased resolution. The grating is configured to have a diffraction angle at the up-limit of 80 to 90 degrees for the single pass structure and to have the near up-limit diffraction angle of 73 to 90 degrees for the double, triple, and quadruple-pass structure.

### CROSS-REFERENCE TO RELATED APPLICATIONS

This application is a non-provisional application claiming the benefit of U.S. Application No. 61/702,332, with a priority date of Sep. 18, 2012.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention relates generally to single-longitudinal mode (SLM) lasers and microchip lasers. More particularly the invention relates to a single-longitudinal mode laser implementation which utilizes a high resolution filter to select a single-longitudinal mode output from a microchip laser having multiple longitudinal modes.

Single-longitudinal mode (SLM) laser has a wide range of applications such as holography, interferometers, precision measurement, high-resolution spectroscopy, coherent optical communications, and laser trapping or cooling. In the prior art, a variety of single-longitudinal mode lasers have been developed. One approach in achieving SLM operation is through the use of ring laser geometry which is disclosed in U.S. Pat. No. 5,052,815, issued on Oct. 1, 1991 to Nightingale et al. A twisted-mode technique for producing an SLM laser is disclosed by Lukas et al in U.S. Pat. No. 5,164,947, issued on Nov. 17, 1992. Another SLM laser technique utilizes a Brewster polarizer and a birefringent material to form a Lyot filter which narrows the frequency bandwidth for single longitudinal mode operation (U.S. Pat. No. 5,381,427, issued to Wedekind et al. on Jan. 10, 1995). Recently an orthogonal-polarization traveling-wave mode technique for producing SLM laser is disclosed by Ma et al in U.S. Pat. No. 7,742,509, issued on Jun. 22, 2010. More recently key techniques for single-mode and frequency doubling laser have been disclosed by Zhang in U.S. Publication No. USRE43421 E1, published on May 29, 2012.

In the prior art, all the SLM lasers have utilized intra-cavity frequency selecting methods to realize single longitudinal mode performance. The drawback of the prior art of SLM lasers is that they are relatively complicated, bulky, and expensive.

### BRIEF SUMMARY OF THE INVENTION

The present invention presents a compact and easy-to-use implementation of an SLM laser via a microchip laser, comprising a pump light source and a laser cavity. A microchip laser normally has a cavity length in the range of 1-10 mm or typically 2.5 mm for a 532 nm green microchip laser. Most microchip lasers have multiple-longitudinal mode output because the gain band width is larger than the frequency separation of two adjacent longitudinal modes. For example, the wavelength difference of two adjacent longitudinal modes is about 0.03 nm for a typical 532 nm green microchip laser having 2.5 mm total cavity length.

A single longitudinal mode may be generated from a microchip laser if the multiple longitudinal modes can be separated and selected by an external filter. But it is difficult to make such a filter because separating two adjacent longitudinal modes with narrow wavelength differences requires very high resolution. Therefore a high resolution filter (hereafter referred to as HR filter) for making an SLM laser with a microchip is desirable. The HR filter should be able to efficiently select a single longitudinal mode as the output from a microchip laser having multiple longitudinal modes. An HR filter most likely utilizes diffraction gratings as the mode-selection component for high resolution and high efficiency.

In the present invention, the microchip laser includes a pump source, a laser cavity, and a plurality of collimating lenses. There are two types of laser cavities: the single lasing material cavity with coatings for fundamental frequency operation and the two-component cavity with lasing and frequency doubling materials with coatings for intra-cavity frequency doubling operation. The present invention provides broad wavelength selection from visible to near infrared. The advantages of the present invention include compact size, low cost, and ease-of-use.

One aspect of the present invention is the apparatus and methods in which the HR filter comprises a grating and plurality of optic components with unique structure and configurations. The HR filters may have a single, double, triple, or quadruple-pass construction in which the laser beam is diffracted by the grating once, twice, three, or four times respectively to achieve the required high resolution. One of the keys to enabling the HR filter is that the grating has to be configured to the up-limit diffraction angle of 80-90 degrees for the single-pass structure and to a near up-limit diffraction angle of 73-90 degrees for the double, triple, or quadruple-pass structure.

The major object of this invention is to develop a compact SLM laser by utilizing a microchip laser with multiple longitudinal modes and an external HR filter to select a single longitudinal mode as the output.

Another object of this invention is to provide a method of generating an SLM laser via an HR filter to select a single longitudinal mode from the multiple longitudinal modes of a microchip laser.

### BRIEF DESCRIPTION OF THE DRAWINGS

A clear understanding of the key features of the invention summarized above may be had by reference to the appended drawings, which illustrate the method and system of the invention, although it will be understood that such drawings depict preferred embodiments of the invention and, therefore, are not to be considered as limiting its scope with regard to other embodiments which the invention is capable of contemplating.

FIG. 1 is an illustration of the method and system of this invention showing a SLM laser comprised of a microchip laser having an output of multiple longitudinal modes and a HR filter for selecting a single longitudinal mode as the final output.

FIG. 2 is an illustration of the method and system of this invention showing (a) a grating at standard Littrow configuration; (b) a grating at the up-limit configuration in which the diffraction angle is in the up limit of 80 to 90 degree to achieve the required high resolution.

FIG. 3 is an illustration of the method and system of this invention showing two longitudinal modes using the grating at the up-limit configuration (a) is unable to be separated spatially in the case of diversion beam; (b) needs large distance to be separated spatially in case of collimated beam; (c) is able to be separated at the focal point in a conversion beam.

FIG. 4 is an illustration of the microchip laser (a) with the laser cavity of single material for fundament frequency output; (b) with the laser cavity of two materials for intra-cavity frequency doubling output.

FIG. 5 is an illustration of a preferred embodiment of the SLM laser of this invention having a microchip laser with the multiple longitudinal modes and a single-pass structured HR filter which spatially separates the multiple longitudinal modes and selects a single longitudinal mode as the output.

FIG. 6 is an illustration of an alternate preferred embodiment of the SLM laser of this invention the same as illustrated in FIG. 5 but having two additional collimating lenses to collimate the single longitudinal mode output.

FIG. 7 is an illustration of a preferred embodiment of the SLM laser of this invention having a microchip laser and a double-pass HR filter.

FIG. 8 is an illustration of an alternate preferred embodiment of the SLM laser of this invention having a microchip laser and a double-pass HR filter.

FIG. 9 is an illustration of a preferred embodiment of the SLM laser of this invention having a microchip laser and a triple-pass HR filter.

FIG. 10 is an illustration of a preferred embodiment of the SLM laser of this invention having a microchip laser and a quadruple-pass HR filter.

FIG. 11 is an illustration of an alternate preferred embodiment of the SLM laser of this invention having a microchip laser and a quadruple-pass HR filter.

### DETAILED DESCRIPTION OF THE INVENTION

Although specific embodiments of the present invention will now be described with reference to the drawings, it should be understood that such embodiments are by way example only merely illustrative of but a small number of the many possible specific embodiments which can represent applications of the present invention. Various changes and modifications obvious to one skilled in the art the present invention pertains are deemed to be within the spirit, scope and contemplation of the present invention.

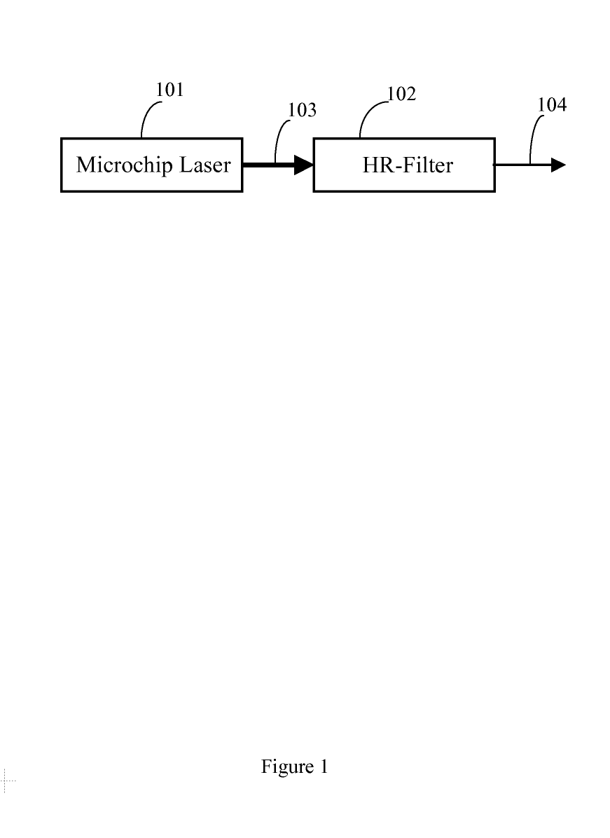

Referring to FIG. 1, the single longitudinal mode (also SLM) laser in the present invention is illustrated by means of a microchip laser 101, which outputs multiple longitudinal modes 103; a high resolution filter 102 (also HR filter), which blocks other adjacent longitudinal modes and selects a single longitudinal mode as the output 104 from the multiple longitudinal modes 103. The SLM laser in the present invention, different from the prior art, utilizes a HR filter as the extra-cavity frequency selecting methods to realize single longitude mode performance.

The output from a microchip laser comprises two or more longitudinal modes. The wavelength difference of two adjacent longitudinal modes depends on the length of laser cavity. A typical 532 nm green microchip laser having 2.5 mm cavity length has, for example, a wavelength difference of about 0.03 nm. The desired HR filter should have enough resolution power to separate the two adjacent longitudinal modes. A grating having high groove density should be utilized to construct the HR filter to have the required high resolution. However, the highest groove density of a grating is limited by the wavelength of the laser beam. For example, the highest groove density is limited to 3760 and 1880 lines per mm for 532 nm and 1064 nm wavelength, respectively. The available grating is 3600 and 1800 lines per mm for 532 nm and 1064 nm, respectively. Even with a high density grating available an up-limit grating configuration must be utilized in constructing the HR filter 102 in order to achieve the required resolution of separating adjacent longitudinal modes.

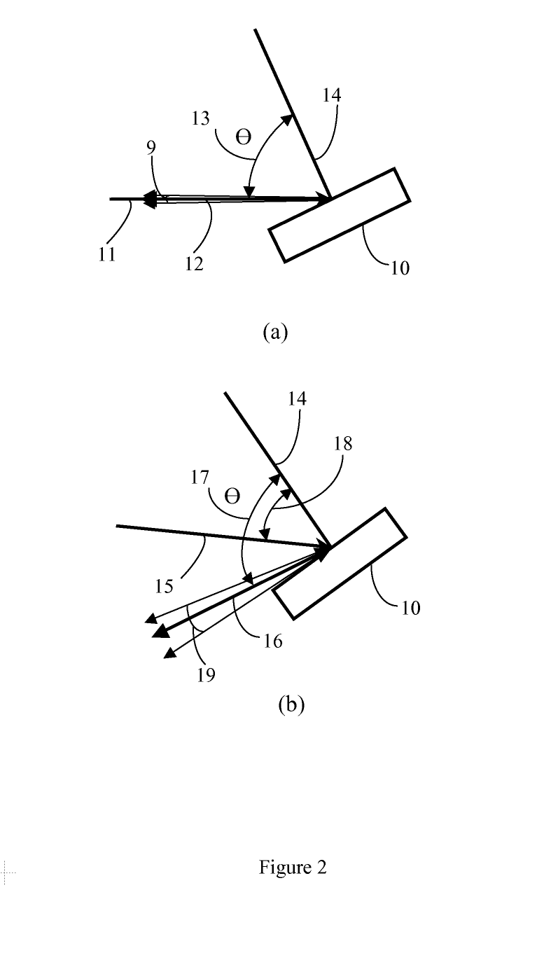

The up-limit configuration is defined as a grating configured to have a diffraction angle in the 80-90 degree range. Referring to FIG. 2(b), the up-limit grating configuration is illustrated. For comparison, FIG. 2(a) illustrates a grating in a conventional Littrow configuration in which the incident angle (θ) 13 of the incident beam 11 and the diffraction angle of the diffracted beam 12 are the same, relative to the surface normal 14 of the grating 10. However, a grating at Littrow configuration does not have the needed resolution power to separate the adjacent longitudinal modes because the angle dispersion 9 of multiple longitudinal modes after diffracted by the grating is relatively small as illustrated in FIG. 2(a). For example, a grating with 3600 grooves per mm at Littrow configuration cannot separate the adjacent longitudinal modes from a 532 nm green microchip laser by about 0.03 nm. However an up-limit configuration, where the diffraction angle is in the 80-90 degree range, can greatly improve the grating dispersion power since the angle dispersion is proportional to 1/cos(θ), where θ is the diffraction angle. As the diffraction angle θ approaches 90 degrees, the angle dispersion becomes very large.

As illustrated in FIG. 2(b), the incident angle 18 of the incident beam 15 relative to the grating 10 is configured such that the diffraction angle (θ) 17 of the diffracted beam 16 is in the range of 80-90 degrees. The incident angle can be determined according to grating equation d(sin(θ1)+sin(θ2))=λ, where d is the grating line distance, λ is the wavelength, θ1 and θ2 are the incident and diffraction angle, respectively. For example the incident angle can be calculated to be 66.8 and 66.3 degree for the diffraction angle of 85 and 88 degrees, respectively, for wavelength 532 nm and a grating with 3600 groove per mm. The angle dispersion 19 of multiple longitudinal modes is increased greatly in the up-limit configuration as illustrated in FIG. 2(b). For example, the resolution (angle dispersion) of the grating at the up-limit diffraction angle 17 θ=85 and 88 degrees is 3.3 and 8.4 times, respectively, of that at Littrow configuration (θ=73 degrees) for a same grating. The greatly increased resolution (angle dispersion) in the up-limit configuration allows us to construct a high resolution (HR) filter with needed resolution and compact size.

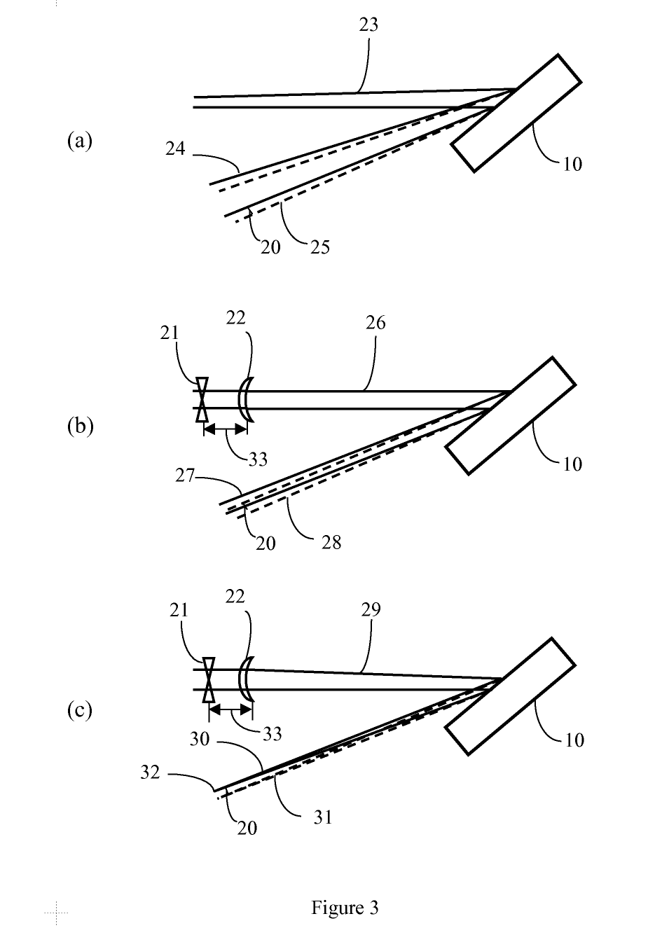

However, the construction of the HR filter is hindered by another problem even with a high resolution grating at the up-limit configuration. Most microchip lasers, with or without collimation lenses, have a beam diversion larger than 1 mRad (0.001 radian or 0.057 degree). The beam diversion is also greatly increased by a grating in the up-limit configuration. The increased beam diversion makes it impossible to separate a single longitudinal mode from the adjacent longitudinal modes. As illustrated in FIG. 3(a) two adjacent longitudinal modes with a diversion beam shape 23 are sent to the grating 10 at the up-limit configuration. The two adjacent longitudinal modes 24 (solid line) and 25 (dashed line) are dispersed with a dispersion angle 20 after the grating 10. Since the beam diversion of the two longitudinal modes after the grating is larger than the dispersion angle 20 the two adjacent longitudinal modes cannot be separated in this case.

To solve the beam diversion problem we have utilized a collimating lens unit, which comprises at least two lenses 21 and 22 separated by a separation distance 33, in front of the HR filter to produce a collimated beam or a conversion beam as illustrated in FIGS. 3(b) and 3(c), respectively. FIG. 3(b) illustrates the case of collimated beam shape 26, in which the two adjacent longitudinal modes are collimated by the lens 21 and 22 and then sent to the grating 10. After the grating 10 the two modes are dispersed with a dispersion angle 20. After certain distance the two adjacent longitudinal modes 27 and 28 will be separated since the beam shape of the two modes keeps collimated after the grating 10. The drawback of the collimated beam shape is that the distance to separate adjacent longitudinal modes could be very large.

For a compact HR filter, a short separation distance is desired. A conversion beam shape is utilized to separate adjacent longitudinal modes more efficiently. As illustrated in FIG. 3(c) the two adjacent longitudinal modes are shaped to a conversion beam 29 by adjusting the distance between the beam shaping lens 21 and 22 and are sent to the grating 10. After the grating 10 the two longitudinal modes 30 and 31 are also dispersed with a dispersion angle 20. However the two modes are focused after the grating 20 in this case. Therefore the two adjacent modes 30 and 31 are completely separated at the focal point position 32 as illustrated in FIG. 3(c). An aperture can be placed at the focal point to select only one longitudinal mode to pass through as the output. The distance of the focal point 32 from the grating 10 depends on the beam conversion and is adjustable by the distance between the collimating lenses 21 and 22. A very compact HR filter can be constructed with a conversion beam shaping and a grating at up-limit configuration.

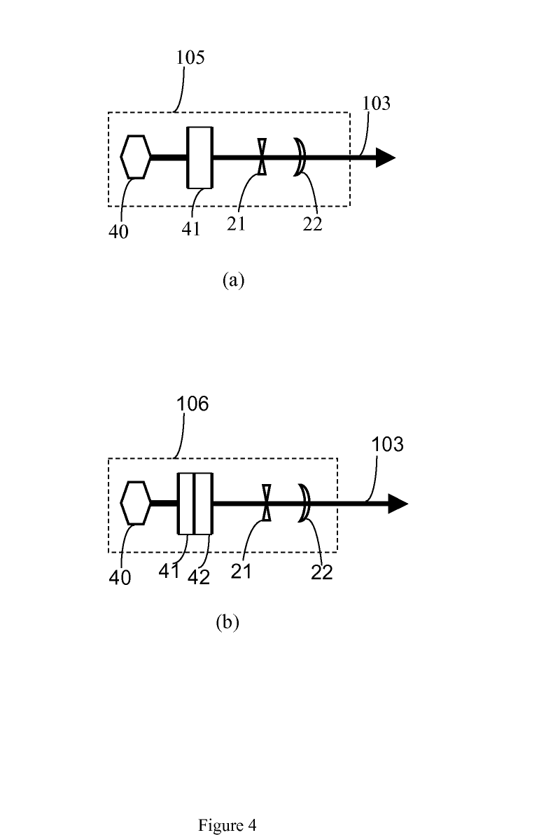

Referring to FIG. 4, two types of microchip lasers having multiple longitudinal modes output in the present invention are illustrated. FIG. 4 (a) illustrates a fundamental microchip laser 105 consisting of a laser pump source 40, a laser cavity 41 comprising a lasing material with coatings for fundamental frequency output, and collimating lenses 21 and 22 separated by a separation distance 33 for beam shape control. FIG. 4 (b) illustrates a frequency-doubling microchip laser 106 consisting of a laser pump source 40, a laser cavity comprising a lasing material 41 and a frequency doubling material 42 with coatings for frequency doubling output, and the collimating lens 21 and 22 separated by a separation distance 33. The lasing material can be Nd:YAG, Yb:YAG, Nd:YVO₄, Nd:GdVO₄, Nd:YLF and Nd:KGW crystals. The frequency doubling materials can be Beta-Barium Borate (BBO), Lithium Borate (LBO), and numerous other materials such as BiBO, KDP, KTP, and KTA crystals.

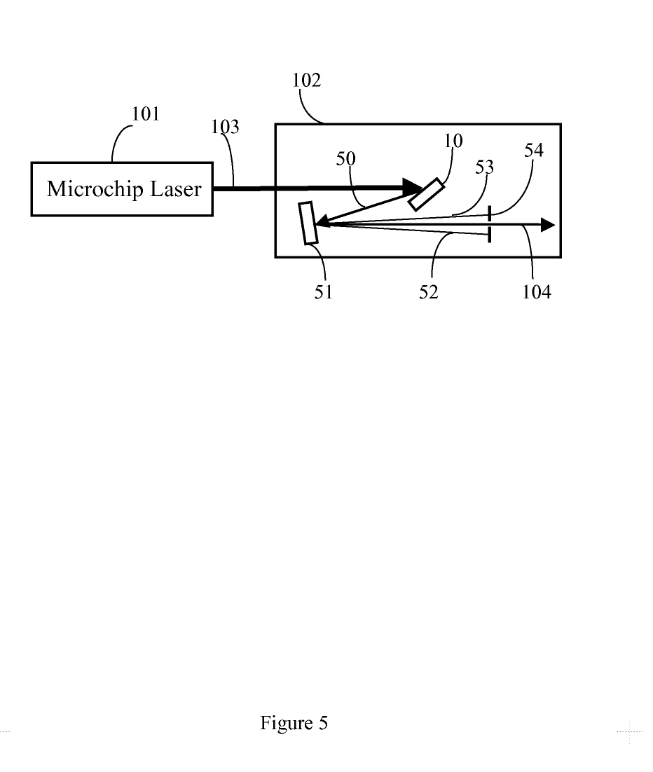

Referring to FIG. 5, a preferred embodiment of the SLM laser in the present invention having the HR filter 102 with a single-pass structure is illustrated. The SLM laser comprises a microchip laser 101 and a HR filter 102. The laser beam is shaped to a conversion beam by the collimating lenses inside the microchip laser. The multiple longitudinal modes 103 from the microchip laser 101 are sent to the HR filter 102 for selecting a single longitudinal mode as the output 104. The HR filter 102 comprises a grating 10 having the up-limit configuration, a reflection mirror 51, and an aperture 54 for spatial filtering. The multiple longitudinal modes 103 with conversion beam shape are dispersed by the grating 10 with an up-limit diffraction angle of 80-90 degrees. The dispersed longitudinal modes 50 from the grating 10 are redirected by the mirror 51 to the aperture 54. The aperture 54 blocks any other longitudinal modes 52 and 53 and allows only one longitudinal mode to pass through as the single longitudinal mode output 104.

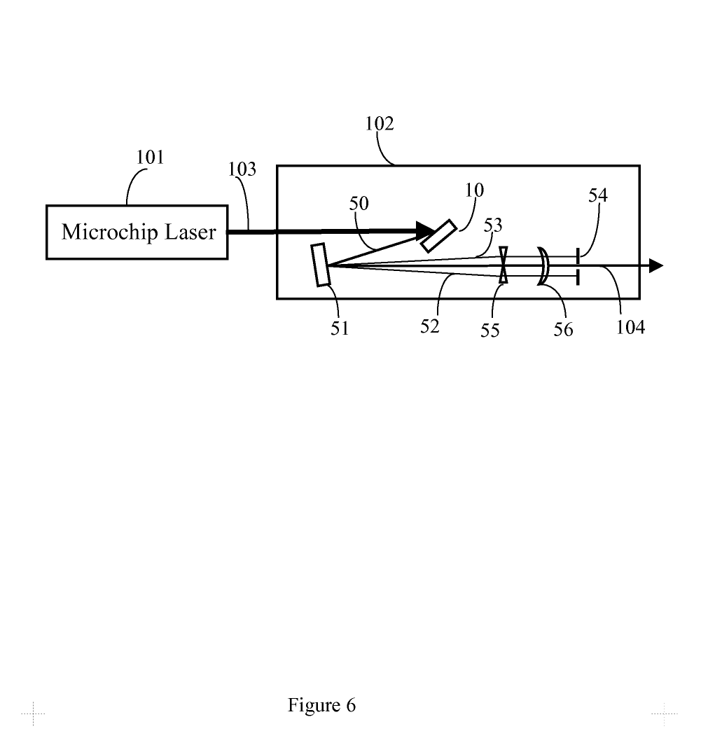

Referring to FIG. 6, an alternate preferred embodiment of the SLM laser in the present invention having the HR filter 102 with a single-pass structure is illustrated. The differences of this SLM laser from the one shown in FIG. 5 are the two collimation lenses 55 and 56 being added into the HR filter. The first collimation lens 55 is a diversion lens to expand the beam size. The second collimation lens 56 is a conversion lens to collimate the single longitudinal mode output 104.

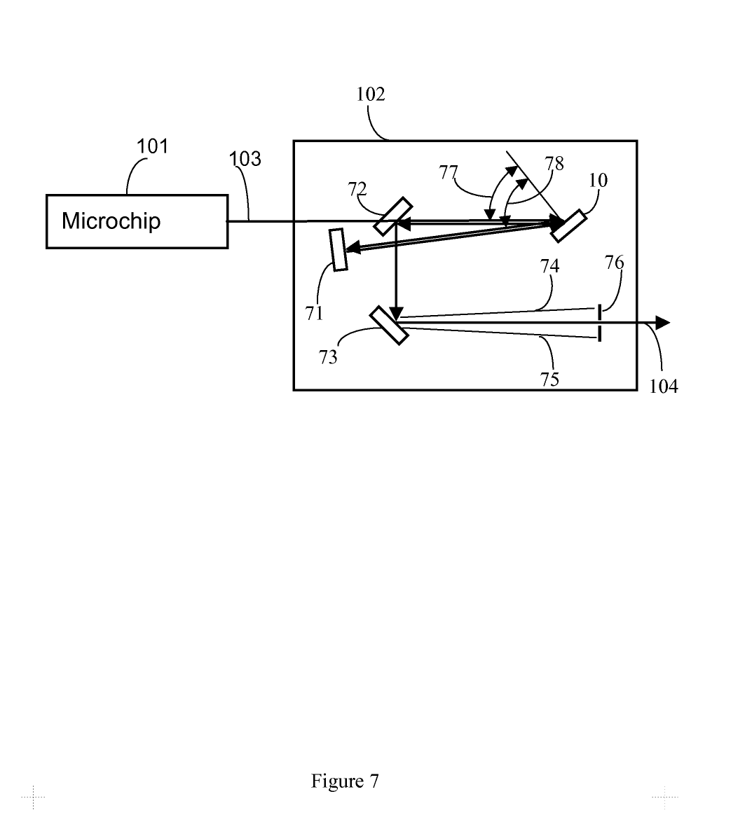

Referring to FIG. 7, an alternate preferred embodiment of the SLM laser in the present invention having the HR filter 102 with a double-pass structure is illustrated. The SLM laser comprises a microchip laser 101 and a HR filter 102 having a double-pass structure for increased wavelength separation power. The laser beam is shaped to a conversion beam by the collimation lenses inside the microchip laser. The multiple longitudinal modes 103 from the microchip laser 101 are sent to the HR filter 102 for selecting a single longitudinal mode as the output 104. The HR filter 102 comprises a grating 10, mirrors 71, 72, and 73, and an aperture 76. For the increased resolution of the double-pass HR filter the grating may be configured at the near up-limit configuration of somewhat smaller diffraction angle. The laser beam of the multiple longitudinal modes 103 with a conversion beam shape is diffracted a first time by the grating 10 to mirror 71 and then is reflected back to the grating 10 by mirror 71 and is diffracted a second time by the grating to mirror 72. The dispersed laser beam then is redirected by the mirror 72 to the mirror 73 and then to the aperture 76 which selects a single longitudinal mode to pass through as the final output 104, while other adjacent longitudinal modes 74 and 75 are blocked by the aperture 76. One of the features of the double-pass HR filter is that the first-time diffraction angle 77 formed when the beam diffracts from grating 10 to mirror 71, is within the near up-limit configuration range of 73-90 degrees. The first-time diffraction angle is larger than the second-time diffraction angle 78 formed when the beam diffracts from grating 10 to mirror 72. This double-pass HR filter has a relative lower resolution power compared to another double-pass HR filter discussed below.

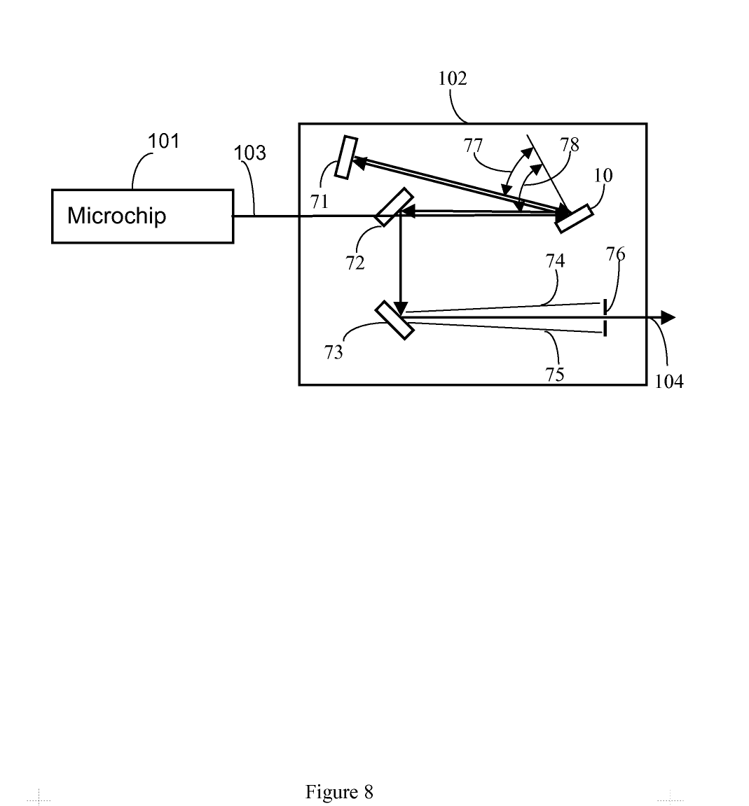

Referring to FIG. 8, an alternate preferred embodiment of the SLM laser in the present invention having the HR filter 102 with a double-pass structure is illustrated. The differences of this SLM laser from the one shown in FIG. 7 are the different position of the reflection mirror 71. This double-pass HR filter has the second-time diffraction angle 78 within the near up-limit configuration range and has the second-time diffraction angle 77 larger than the first-time diffraction angle. The resolution power of this double-pass HR filter is relatively higher than that of the double-pass HR filter discussed above where the second-time diffraction angle is smaller than the first-time diffraction angle. The first and second-time diffraction angles will be same in the case of the incident angle and the diffraction angle are the same. Importantly, the first-time diffraction angle may be greater than, less than, or equal to the second-time diffraction angle depending on the resolution power desired.

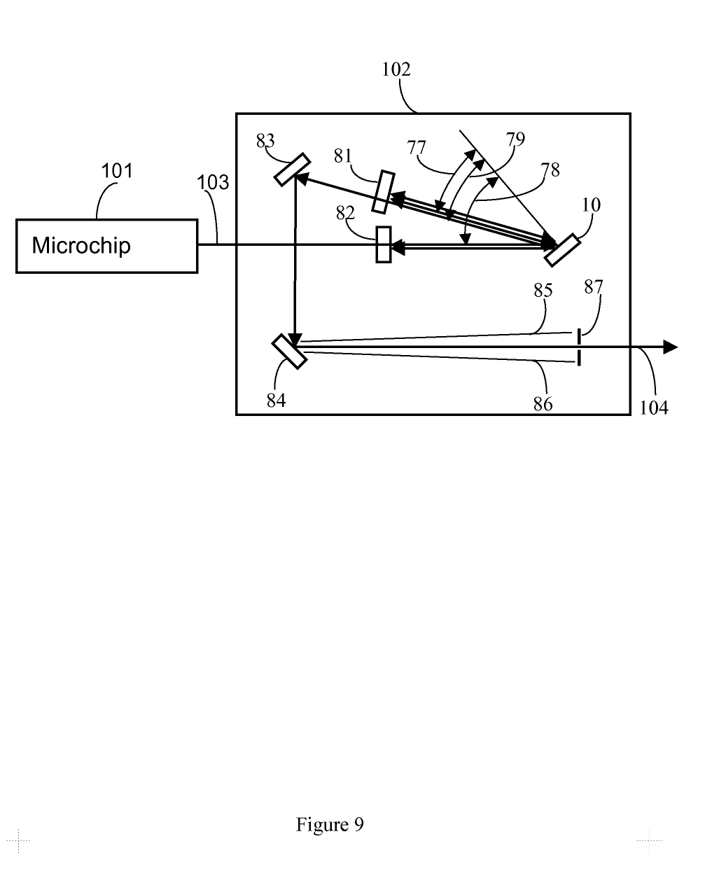

Referring to FIG. 9, an alternate preferred embodiment of the SLM laser in the present invention having the HR filter 102 with a triple-pass structure is illustrated. The SLM laser comprises a microchip laser 101 and a HR filter 102 having a triple pass structure with further increased wavelength separation power. The HR filter 102 includes a grating unit 10 with the near up-limit configuration, the reflection mirrors 81-84, and an aperture 87. The laser beam of the multiple longitudinal modes 103 is diffracted for a first time by the grating 10 to the mirror 81; then the laser beam is reflected back to the grating 10 by the mirror 81 and is diffracted a second time by grating 10 to mirror 82; then the laser beam is reflected back to grating 10 again by mirror 82 and is diffracted a third time by grating 10 to mirror 83, where the third-time diffraction angle is same as the first time-diffraction angle 77; then the laser beam is redirected from mirror 83 to mirror 84, and then to aperture 87; finally a single longitudinal mode is selected to pass through the aperture 87 as the output 104 and other adjacent longitudinal modes 85 and 86 are blocked by the aperture 87. The first-time, second-time, and third-time diffraction angle may be configured to achieve the resolution power desired.

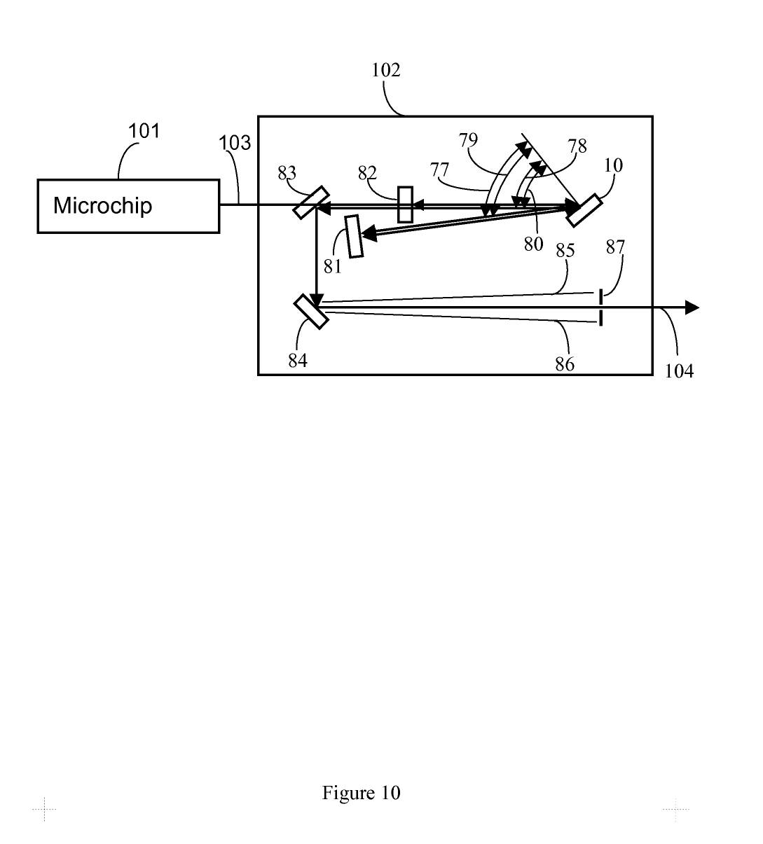

Referring to FIG. 10, an alternate preferred embodiment of the SLM laser in the present invention having the HR filter 102 with a quadruple-pass structure is illustrated. The SLM laser comprises a microchip laser 101 and a HR filter 102 having a quadruple-pass structure with further increased wavelength separation power. The HR filter 102 comprises a grating unit 10 with the near up-limit configuration, the reflection mirrors 81-84, and an aperture 87. The laser beam of the multiple longitudinal modes 103 is diffracted first time by the grating 10 to the mirror 81; then the laser beam is reflected back to the grating 10 by the mirror 81 and is diffracted second time by the grating 10 to the mirror 82; then the laser beam is reflected back to the grating 10 again by the mirror 82 and is diffracted third time by the grating 10 to the mirror 81, where the third-time diffraction angle 79 is the same as the first time-diffraction angle 77; then the laser beam is reflected back to the grating 10 again by the mirror 81; then the laser beam is diffracted fourth time by the grating to the mirror 83, where the fourth-time diffraction angle 80 is the same as the second time-diffraction angle 78; Then the laser beam goes to the mirror 84, and to the aperture 87; finally a single longitudinal mode is selected to pass through the aperture as the output 104 and other adjacent longitudinal modes 85 and 86 are blocked by the aperture 87. The quadruple-pass HR filter has the first and third-time diffraction angles in the near up-limit configuration range and has the second and fourth-time diffraction angles smaller. This quadruple-pass HR filter has a relatively lower resolution power compared to another quadruple-pass HR filter discussed below.

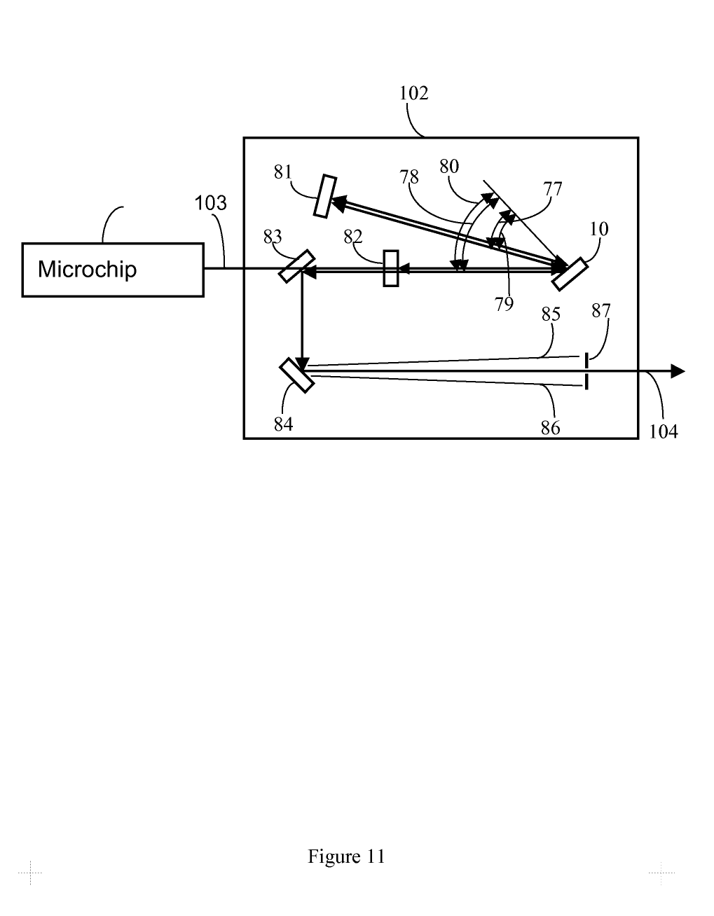

Referring to FIG. 11, an alternate preferred embodiment of the SLM laser in the present invention having the HR filter 102 with a quadruple-pass structure is illustrated. The SLM laser comprises a microchip laser 101 and a HR filter 102 having a quadruple- pass structure same as that shown in FIG. 10 but with one difference. The difference is that the reflection mirror 81 is located above the incident beam 103 in this HR filter while the reflection mirror 81 is located below the incident beam 103 in that shown in FIG. 10. Similarly, the multiple longitudinal modes 103 are diffracted four times by the grating 10 and finally a single longitudinal mode is selected as the output 104. The quadruple-pass HR filter has the second and fourth time diffraction angles in the near up-limit configuration range and has the first and third time diffraction angles smaller, where the third-time diffraction angles 79 is same as the first-time diffraction angle 77 and the fourth-diffraction angle 80 is same as the second-time diffraction angle 78. This quadruple-pass HR filter has a relatively higher resolution power compared to another quadruple-pass HR filter discussed above.

Although the invention has been explained in relation to its preferred embodiment, it is to be understood that many other possible modifications and variations can be made without departing from the spirit and scope of the invention as herein described.

What is claimed is:

1. A single longitudinal mode laser device, comprising:
a microchip laser generating a laser beam with multiple longitudinal modes; and
a high-resolution filter operatively coupled to the microchip laser to output a laser beam with a single longitudinal mode.

2. The device of claim 1 wherein the microchip laser further comprises a laser pump source, a laser cavity, and one or more optical lenses.

3. The device of claim 1 wherein the high-resolution filter further comprises a plurality of gratings, reflection mirrors, and apertures.

4. The device of claim 2 wherein the laser cavity further comprises a lasing material with one or more coatings for fundamental frequency output.

5. The device of claim 2 wherein the laser cavity further comprises a lasing material and a frequency doubling material with one or more coatings for frequency doubling output.

6. The device of claim 2 wherein the optical lenses are arranged in a way to produce a collimated or conversion laser beam shape.

7. The device of claim 3 wherein the laser beam with multiple longitudinal modes is directed to be diffracted by the grating at least once.

8. The device of claim 3 wherein the grating is configured to diffract the laser beam at an angle between 80 and 90 degrees and the laser beam is diffracted by the grating no more than once.

9. The device of claim 3 wherein the grating is configured to diffract the laser beam at an angle between 73 and 90 degrees and the laser beam is diffracted by the grating more than once.

10. The device of claim 3 wherein the diffraction angle the laser beam forms as it is diffracted from the grating for the first time is equal to or less than the diffraction angle the laser beam forms as it is diffracted from the grating for the second time.

11. The device of claim 3 wherein the diffraction angle the laser beam forms as it is diffracted from the grating for the first time is equal to the diffraction angle the laser beam forms as it is diffracted from the grating for the third time.

12. The device of claim 3 wherein the diffraction angle the laser beam forms as it is diffracted from the grating for the first time is equal to the diffraction angle the laser beam forms as it is diffracted from the grating for the third time, the diffraction angle the laser beam forms as it is diffracted from the grating for the second time is equal to the diffraction angle the laser beam forms as it is diffracted from the grating for the fourth time, and the first and third-time diffraction angles are equal to, or smaller, or larger than the second and fourth-time diffraction angles.

13. The device of claim 3 wherein the power of the device to resolve multiple longitudinal modes increases with the number of times the laser beam is directed to be diffracted by the grating.

14. The device of claim 3 wherein at least one aperture selects a single longitudinal mode as the output.

15. A method for selecting a single longitudinal mode from a laser beam with multiple longitudinal modes, which comprises:
generating a laser beam with multiple longitudinal modes via a microchip laser;
adjusting the laser beam into a collimated or conversional shape via optical lenses;
spatially separating the multiple longitudinal modes of the laser beam by diffracting it one or more times from a grating; and
selecting a single longitudinal mode as the output via an aperture.

16. The method of claim 15 further comprising using a lasing material with coatings for fundamental frequency output and using a lasing material and a frequency-doubling material with coatings for frequency-doubling output.

17. The method of claim 15 further comprising increasing the ability to spatially separate longitudinal modes by increasing the number of times the laser beam with multiple longitudinal modes is directed to be diffracted from the grating.

18. The method of claim 15 further comprising diffracting the laser beam at an up-limit diffraction angle of 80 to 90 degrees.

19. The method of claim 15 further comprising diffracting the laser beam at a near up-limit diffraction angle of 73 to 90 degrees.
